(19) United States
(12) Patent Application Publication
(10) Pub. No.: US 2024/0078177 A1
(43) Pub. Date: Mar. 7, 2024

(54) SYSTEMS AND METHODS FOR PREDICTIVE CACHE MANAGEMENT BASED UPON SYSTEM WORKFLOW

(71) Applicant: RELATIVITY ODA LLC, Chicago, IL (US)

(72) Inventors: Jeffrey Hibser, Chicago, IL (US); Mohammad Amer Ghazal, Chicago, IL (US); Steven Engelhardt, Chicago, IL (US); Ankit Khandelwal, Chicago, IL (US); Ranga Sankar, Chicago, IL (US)

(21) Appl. No.: 18/240,778

(22) Filed: Aug. 31, 2023

Related U.S. Application Data
(60) Provisional application No. 63/403,080, filed on Sep. 1, 2022.

(51) Int. Cl. G06F 12/06

(52) U.S. Cl. CPC G06F 12/063

(57) ABSTRACT

Techniques for predictively configuring a cache are provided. A method includes (1) identifying, via one or more processors, a workflow configured to interact with a cache paired to a cloud storage system; (2) predicting, via the one or more processors, an expected input output operations (IOPS) pattern for transactions generated by the workflow, wherein the IOPS pattern is indicative of a proportion of read operations to write operations; and (3) configuring, via the one or more processors, one or more cache management workers based upon the expected IOPS pattern.

### CROSS-REFERENCE TO RELATED APPLICATIONS

This application claims priority to U.S. provisional patent application No. 63/403,080, filed on Sep. 1, 2022, entitled “SYSTEMS AND METHODS FOR PREDICTIVE CACHE MANAGEMENT BASED UPON SYSTEM WORKFLOW” the entire disclosures of which is hereby incorporated herein by reference.

### FIELD OF THE DISCLOSURE

The present disclosure relates generally to predictively configuring a cache manager, and more particularly to predictively configuring the cache manager based upon an expected input/output operations (IOPS) pattern.

### BACKGROUND

When providing software services to customers, the customer data is typically maintained at a cloud storage system. This enables the service provider to readily scale the amount of storage provided based upon customer demand. However, interfacing with data stored in the cloud storage system is typically slower than if the customer data was maintained in an on-premises solution due to the need to interface with an external storage system. As a result, when the software service needs to interact with the customer data, the software service typically interacts with a copy of the customer data maintained at a local cache. Because this cache is local to the software service, the software service is able to execute tasks that interact with the customer data in a quicker manner.

There are typically competing demands on the cache depending upon the particular workflows performed by the software services. For example, workflows that relate to collecting and/or modifying customer data typically involve more write operations to the cloud-based storage system to store the new and/or modified customer data. As such, a cache is more efficiently operated if the data can be efficiently evicted from the cache upon being written to the cloud storage system. On the other hand, workflows that relate to presenting a large number of documents to users (e.g., during a document review process) involve more read operations from the cloud storage system to be able to quickly present the documents to users. In this scenario, the cache is more efficiently operated if it is “warmed,” or pre-loaded with additional documents related to a current task, such that users can quickly view additional documents.

As such, there are competing demands on a cache manager to efficiently remove data from the cache when writing to the cloud storage system, yet loading as much data as possible when reading data from the cloud storage system. Accordingly, the cache manager may analyze an IOPS pattern to determine whether to cache should be optimized to support a read-heavy workflow, a write-heavy workflow, or a balanced workflow.

However, the instantaneous IOPS pattern may mislead the cache manager as to proper way to efficiently manage the cache. For example, a workflow may include multiple steps that switch between generating a read-heavy IOPS pattern and a write-heavy IOPS pattern. Accordingly, by continuing to manage the cache near the end of a read-heavy stage of the workflow based on the instantaneous read-heavy IOPS pattern may cause the cache to be inefficiently configured at the onset of a subsequent write-heavy stage of the workflow. As a result, the write-heavy stage of the workflow may take longer to process.

In view of the foregoing challenges, there is a need for systems and methods of predictive cache management based upon system workflows.

### BRIEF SUMMARY

In one embodiment, a computer-implemented method for predictive cache management is provided. The method includes (1) identifying, via one or more processors, a workflow configured to interact with a cache paired to a cloud storage system; (2) predicting, via the one or more processors, an expected input output operations (IOPS) pattern for transactions generated by the workflow, wherein the IOPS pattern is indicative of a proportion of read operations to write operations; and (3) configuring, via the one or more processors, one or more cache management workers based upon the expected IOPS pattern.

In another embodiment, a system for predictive cache management is provided. The system includes (i) a cache; (ii) one or more processors; and (iii) one or more non-transitory memories coupled to the one or more processors and storing instructions that when executed by the one or more processors, cause the one or more processors to (1) identify a workflow configured to interact with the cache paired to a cloud storage system; (2) predict an expected input output operations (IOPS) pattern for transactions generated by the workflow, wherein the IOPS pattern is indicative of a proportion of read operations to write operations; and (3) configure one or more cache management workers based upon the expected IOPS pattern.

In yet another embodiment, a non-transitory computer-readable medium storing instructions for predictive cache management is provided. The instructions, when executed via one or more processors of a computer system, cause the computer system to (1) identify a workflow configured to interact with a cache paired to a cloud storage system; (2) predict an expected input output operations (IOPS) pattern for transactions generated by the workflow, wherein the IOPS pattern is indicative of a proportion of read operations to write operations; and (3) configure one or more cache management workers based upon the expected IOPS pattern.

### BRIEF DESCRIPTION OF THE DRAWINGS

FIG. 1 illustrates an example environment that may be used to implement the techniques for predictive cache management, according to an embodiment;

FIGS. 2A and 2B illustrate example workflows that interact with a cache managed in accordance with the disclosed predictive cache management techniques;

FIG. 3 illustrates an example workflow profiler, in accordance with an embodiment; and

FIG. 4 depicts an example flow diagram of a method for predictive cache management, according to an embodiment.

### DETAILED DESCRIPTION

### I. Overview

The present techniques relate to predictively managing a cache based upon an expected input/output operations (IOPS) pattern for interactions with a cloud storage system configured to store a plurality of documents and/or objects. As it is used herein, the term “document” refers to any collection of data that conveys information to a user of a client device and/or an application executing on a client device. For example, the document may be a Microsoft Word file, a text file, an email, a pdf, a presentation, a spreadsheet, an image, a messaging file format, an audio file, and/or other documents. As it is generally used herein, an object refers to any type of data that can be represented by a software object (e.g., a document file, document fragment, a metadata file, an unstructured data file, and/or other data types). Accordingly, the term “document” may refer to either the document file (e.g., a .doc or .txt file) or the corresponding object(s) from which the document (or a portion thereof) can be derived.

Generally, there are two main operations performed by software systems with respect to documents maintained at the cloud storage system—(1) read operations where a document is obtained from the cloud storage system, and (2) write operations where new documents are written to the cloud storage system or changes to existing documents at the cloud storage system are propagated to the copy maintained thereat. For read operations, the documents obtained from cloud storage system are stored in a local cache where applications supported by the software system can quickly interface with the document. For example, the documents read into the cache may be presented for display by a user interface application, processed by a data processing application, such as an OCR processing application or a PDF converter, or other operations supported by the software system.

For write operations, the cache may also serve as a staging area where documents (and/or changes thereto) are stored until they have been successfully written to the cloud storage system. As one example, a document collection application may detect that a user uploaded a set of documents to a workspace. Accordingly, the cache may be configured to store the collected documents while they are being written to the cloud storage system. As another example particular to a document review process, a reviewer may have made one or more coding decisions with respect to an assigned batch of documents. Accordingly, the copies of the documents read into the cache are updated to reflect the coding decisions of the reviewer. Thus, the cache may store the updated copies of the documents that are to be written back to the cloud storage system.

Techniques described herein advantageously analyze a current workflow to predict an expected IOPS pattern for interactions with the cloud storage. That is, the techniques described herein attempt to predict a proportion of read operations to write operations that will occur over time as a result of executing the current workflows. As a result, the configuration of the cache paired to the cloud storage system can be adapted to ensure that the storage associated with the cache is allocated in a manner that ensures efficient processing of the workflows.

### II. Example Computing Environment

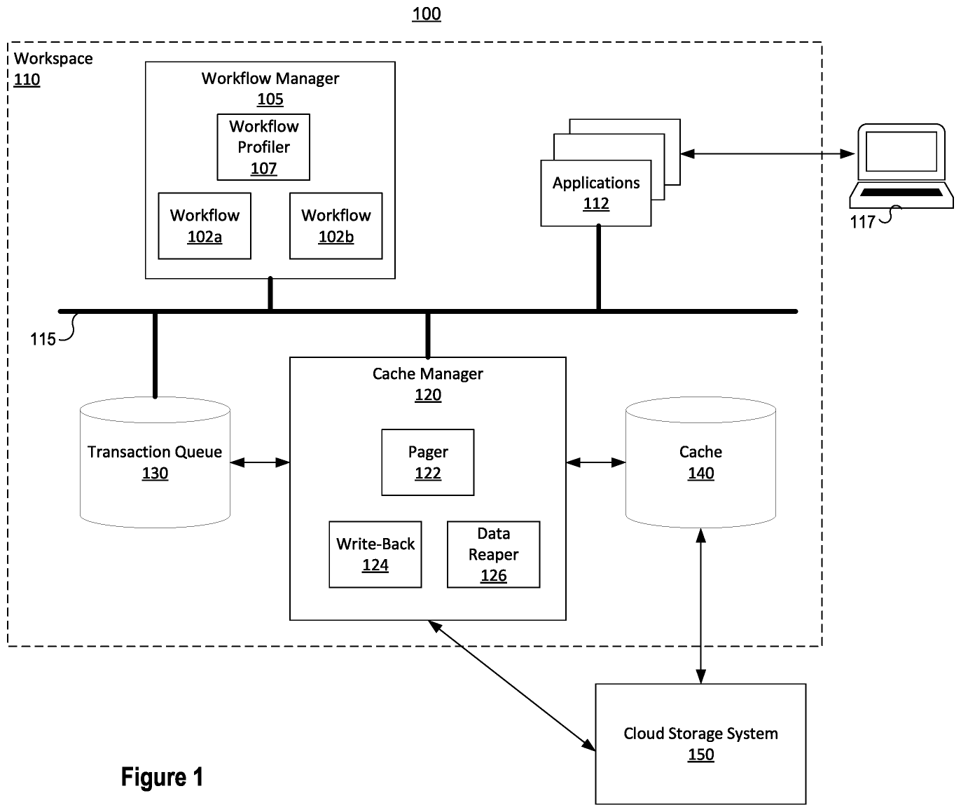

FIG. 1 depicts an example computing environment 100 that may be used to implement the disclosed cache management techniques. As illustrated, the environment 100 includes a workspace 110 that includes a plurality of software modules that implement the disclosed techniques. Generally, the workspace 110 is client- and/or user-specific software environment that enables users to interface with their data maintained within the workspace. In some embodiments, the workspace 110 may be hosted on one or more virtual machines instantiated in a cloud computing environment or an on-premises deployment of servers. Accordingly, the modules of the workspace 110 may be instantiated across any number of different physical computing units that include respective sets of one or more processors (e.g., one or more microprocessors, one or more CPUs, one or more GPUs, etc.).

More specifically, the software modules that are included in the workspace 110 may be instantiated by one or more processors configured to execute software instructions stored in one or more memories of the physical memory (e.g., stored in a persistent memory such as a hard drive or solid state memory). It should be appreciated that certain instructions may be more efficiently executed by different types of processors. Accordingly, the processors that instantiate the various components of the workspace 110 may be configured to execute different instructions using the different processor types. In some embodiments, the workspace 110 may include multiple instantiated copies of any of the components therein to perform the disclosed functionality in parallel with one another.

A first component of the workspace 110 is a cache manager 120 configured to manage a cache 140 in accordance with the techniques disclosed herein. More particularly, the cache manager 120 is configured to process transactions placed in a transaction queue 130 to identify transaction associated with reading data from and/or writing data to a cloud storage system 150 and managing the cache 140 to facilitate the processing of these transactions. Typically, the transaction queue 130 is configured as a first in, first out (FIFO) queue, such that transactions in the queue 130 are processed in the order they are placed therein. That said, in some embodiments, transactions in the queue 130 may processed by the cache manager 120 non-sequentially. Several such techniques for non-sequential processing of transactions in the queue 130 are disclosed in U.S. Provisional Application 63/289,127 filed Dec. 13, 2021, the entire disclosure of which is hereby incorporated by reference.

The cache 140 may implement any storage type, including ephemeral storage, permanent storage, and/or combinations thereof. The cache manager 120 may configure the cache 140 to be paired with a cloud storage system 150 (and/or a particular customer instance maintained thereat). Accordingly, to process a read transaction from the queue 130, the cache manager 120 may transmit an instruction to the cloud storage system to fetch a particular document indicated by the read transaction and store the fetched document in the cache 140. In some embodiments, the cache manager 120 may be configured to batch a plurality of fetch operations into a single instruction. On the other hand, to process a write transaction from the queue 130, the cache manager 120 may be configured to determine whether the cache 140 includes a version of the document referenced by the write transactions, and, if not, store the document to be written in the cache 140. The cache manager 120 may then send an instruction to the cloud storage system to write the referenced document from the cache 140 to the customer instance.

As illustrated, the cache manager 120 includes several functions to assist in management of the cache 140 to process read and write transactions in the queue 130. A first function is a pager 122 configured to assist in reading documents from the cloud storage system 150. The pager 122 may be the function that actually formats and sends the fetch operations to the cloud storage system 150. The pager 122 may be configured to control the amount of data that is to be fetched as part of processing a read transaction. For example, if the cloud storage system is configured to maintain large documents, fetching the entire document in response to each read transaction may rapidly use the entire storage of the cache 140 for data that is not likely to be viewed by a user. Accordingly, the pager 122 may include a configurable setting that indicates an amount of each document (e.g., a percentage of the document, a size of an initial portion of the document, a number of document fragments, etc.) to fetch when interfacing with the cloud storage system 150.

As another example, when one document is associated with a read transaction, a user is often likely to perform an action such that a read transaction is subsequently generated for another document related to that document. Accordingly, for faster processing of the subsequent read transaction for the related document, the cache manager 120 may predictively “warm” the cache 140 with additional documents that are related to the document referenced by a read transaction. Techniques for predictive caching of documents are disclosed in U.S. Provisional Application 63/289,130 filed Dec. 13, 2021, the entire disclosure of which is hereby incorporated by reference. As such, the pager 122 may include one or more configurable settings that adjusts the amount of warming of the cache 140, such as a relevance threshold for inclusion in the warming set, a set of relevance types (e.g., family, semantic, applied tags, etc.) to analyze when warming, a maximum number of relevant documents (either per document or in aggregate), and so on. Documents written to the cache 140 as part of warming the cache 140 may include an indication of the basis for inclusion in the warming process. As a result, if the setting of the pager 122 associated with warming the cache 140 is made stricter, the pager 122 can release a read lock on the documents that no longer comply with the relevance setting.

Another function of the cache manager 120 is a write-back function 124 configured to assist in writing documents stored in the cache 140 to the cloud storage system 150. The write-back function 124 may be the function that actually formats and sends the write operations to the cloud storage system 150. Accordingly, the write-back function 124 may be configured to identify documents in the cache 140 that are associated with a write-lock status. When the write-back function 124 successfully writes a document in the cache 140 to the data storage 150, the write-back function 124 may release the write-lock on the document.

A third function of the cache manager 120 is a data reaper function 126 configured to evict data from the cache 140. More particularly, the data reaper function 126 may be configured to evict unlocked data from the cache 140. Techniques for deleting data in accordance with one or more locks are disclosed in U.S. Provisional Application 63/289,134 filed Dec. 13, 2021, the entire disclosure of which is hereby incorporated by reference.

As part of maintaining the cache 140, the cache manager 120 may scale up or down a number of workers assigned to the functions 122-126 to dedicate additional or fewer resources to performing the function. When the cache manager 120 may scales up the write-back function 124, the cache manager 120 is able to write more data to the cloud storage system 150 more quickly. This creates more data in the cache 140 that has a released write-lock. As such, the cache manager 120 typically also scales up the data reaper function 126 to more aggressively evict the write-unlocked data when scaling up the write-back function 124.

As illustrated, the back-end 104 also includes a workflow manager 105 configured to execute and/or process workflows 102. Generally, a workflow is a set of logic that is automatically executed by the back-end 104. The logic is formed of function blocks that include a trigger condition that, when detected, generates transactions that results in the performance one or more pre-determined actions. The logic may be manually defined by a user, for example, interfacing with a workflow editor. Additionally or alternatively, the logic may be automatically defined by an application. For example, a document review application may generate and deploy a workflow in response to detecting that a review queue is enabled. Regardless of how the logic is defined, the workflows 102 may be deployed for automatic execution thereof. Techniques for defining and deploying workflows are described in U.S. application Ser. No. 17/152,985 filed Jan. 20, 2021, the entire disclosure of which is hereby incorporated by reference.

As illustrated, the workspace 110 includes a set of applications 112 via which a user interfaces with the customer data via a client device 117. The workspace 110 and the client device 117 may be communicatively coupled via one or more wired or wireless network(s) that facilitate any current or future-developed standard or technology (e.g., GSM, CDMA, TDMA, WCDMA, LTE, EDGE, OFDM, GPRS, EV-DO, UWB, IEEE 802 including Ethernet and Wi-Fi, WiMAX, Bluetooth, and others). Accordingly, the client device 117 can be a mobile phone, a desktop computer, a laptop computer, a tablet, a smart wearable device, a home personal assistance device, or any other suitable type of computing device capable of communicating over a communication network with the workspace 110.

Based on client interactions, the applications 112 may generate a workflow 102 that is executed by a workflow manager 105. For example, a first application 112 may be a workflow editor that enables the user to manually define a workflow 102. As another example, a second application 112 may be a document production application that performs one or more production operations (e.g., burn a set of redactions into an image) on documents that are associated with a particular coding decision.

The modules of the workspace 110 may communicate with one another via one or more buses 115. For example, the buses 115 may a message bus that is accessible by a plurality of the software modules in the workspace 110. The software modules may be configured to record events to the message bus as they happen. For example, as the workflow module 105 may write messages to the message bus to initiate an action indicated by a workflow 102 at a particular software module. The software module may also write messages back to the message bus to inform the workflow module 105 as to the status of executing the action. In some embodiments, the buses 115 may also include a separate bus for transactions that read or write data to the cloud storage 150.

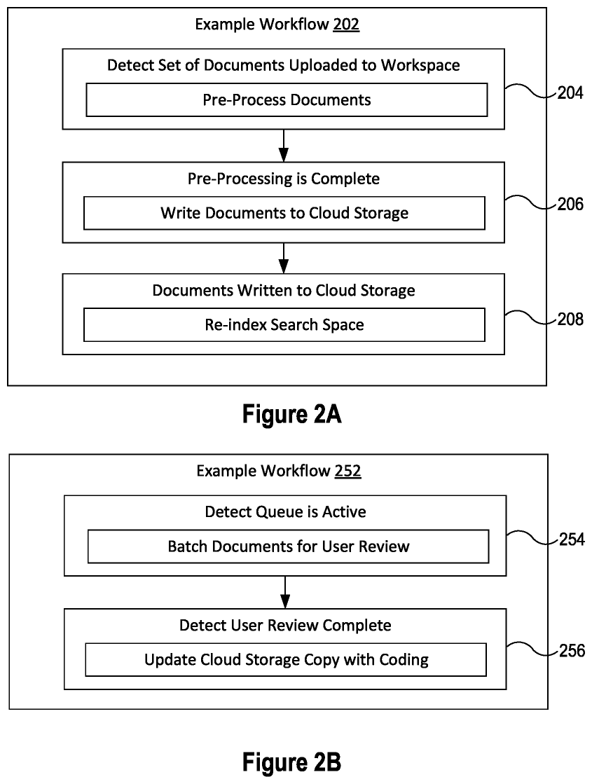

With simultaneous reference to FIGS. 2A and 2B, illustrated are example workflows 202, 252 that may be executed by workflow manager 105. For example, the example workflows may be the workflows 102a and 102b of FIG. 1. It should be appreciated that while the example workflows 202, 252 are examples of serial workflows, other workflows may implement more advanced logic that includes function blocks that operate in parallel to one another.

The example workflow 202 is a workflow related to the ingestion of additional documents into the workspace 110. As illustrated, the workflow 202 includes three function blocks 204-208. The first function block 204 is configured to detect that a set of new documents were uploaded to the workspace 110 and to pre-process the documents. For example, the pre-processing may include identifying entities associated with the documents and/or performing an email threading process to reduce the number of documents. The second function block 206 detects when the pre-processing is complete and then writes the processed documents to the cloud storage system 150. Accordingly, the workflow manager 105 may generate write transactions respectively corresponding to the pre-processed documents and add the transactions to the queue 130. As such, the function block 206 is associated with a write-heavy transaction flow. The third function block 308 detects that the documents have been successfully written to the cloud storage system 150 and executes a command to re-index a search space (e.g., a dtSearch index) such that the new documents can be found when executing a search.

The example workflow 252 is a workflow associated with a document review process. As illustrated, the workflow 252 includes two function blocks 254, 256. The first function block 254 detects that a document review queue is now active and in response, generates a batch of documents for user review. Accordingly, the workflow manager 105 may generate read transactions respectively corresponding to documents included in the batch of documents and add the transactions to the queue 130. As such, the function block 254 is associated with a read-heavy transaction flow. The second function block 256 detects that user review of the batch of documents is complete and updates the cloud storage system 150 with coding decisions applied during the review. As described above, the batch review application may update the copy of the document in the cache 140 with the corresponding coding decisions thereby signaling a need to write the updated copy of the document back to the cloud storage system 150. As such, the function block 254 is associated with a write-heavy transaction flow.

Returning to FIG. 1, the workflow manager 105 includes a workflow profile 107 configured to predict an expected IOPS pattern based upon the pending workflows 102. Based upon the expected IOPS pattern, the workflow profiler 107 may adjust operation of the pager 122 and/or scale up or down the number of workers assigned to the functions 122-126. That is, if the workflow profiler 107 expects a read-heavy IOPS pattern, the workflow profiler may increase the amount of data warmed into the cache 140 and/or scale up the number of pager workers. On the other hand, if the workflow profiler 107 expects a write-heavy IOPS pattern, the workflow profiler 107 may reduce the amount of data warmed into the cache 140 and/or scale up the number of write-back and data reaper workers. It should be appreciated that the workflow profiler 107 may scale the response to the expected IOPS pattern in proportion to the read-heavy or write-heavy nature of the expected IOPS pattern.

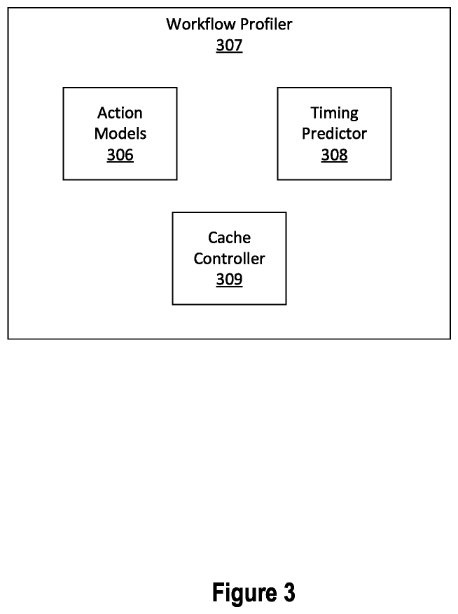

Generally, there are two components to predicting the expected IOPS pattern associated with a workflow, (1) predicting an IOPS pattern associated with the actions indicated by the function blocks of the workflows 102, and (2) predicting when the IOPS are expected to occur based upon the trigger conditions of the function blocks included in the workflow. With simultaneous reference to FIG. 3, illustrated is an example model for a workflow profiler 307 (such as the workflow profiler 107). As illustrated, the workflow profiler 307 may maintain a model 306 that models the expected IOPS pattern associated with each workflow action. To train the models 306, the workflow profiler 307 may monitor the resultant IOPS pattern when the action is executed. For example, if the action results in a read-heavy IOPS pattern, the corresponding model 306 may indicate the read-heavy nature. It should be appreciated that some actions may not maintain a consistent read/write proportion over the course of its execution. Thus, the models 306 may reflect the shift in the read/write proportion over time. Additionally, the amount of time it takes to execute the action may vary depending upon the number of documents in the workspace 110. Accordingly, when combining the IOPS patterns of past executions to produce the models 306, the workflow profiler 307 may normalize the time scales such that overall shape of the expected IOPS pattern for the action can be combined using one or more modeling and/or regression techniques.

With respect to the timing of the IOPS pattern, the workflow profiler 307 includes the timing predictor 308 configured to analyze the workspace 110 and the function block triggers to predict when the IOPS are expected to occur. For example, the timing predictor 308 may be configured to scale the action model 306 based upon a number of documents the workflow profiler 307 expects the action to operate upon. Additionally, the timing predictor 308 may monitor the workspace 110 to identify when a current workflow action (and/or future workflow actions) to predict when the IOPS pattern indicated by the scaled model 306 will occur. Given the dynamic nature of distributed computing environments, the timing predictor 308 may frequently analyze the state of the workspace 110 and re-update the expected timing of the IOPS pattern using the timing predictor 308. It should be appreciated that the workflow profiler 307 may act upon each of the workflows 102 currently being processed by the workflow manager 105 to build an aggregate expected IOPS pattern.

The workflow profiler also includes a cache controller 309 configured to output the changes in the configuration of the cache manager 120 (e.g., the number of workers for the functions 122-126, a configuration of the pager 122, etc.) based upon the expected IOPS pattern. It should be appreciated that the control parameters output by the cache controller 309 are based on an expected IOPS pattern, not a current IOPS pattern. That is, the cache controller 309 may predictively configure the cache manager 120 prior to the read/write transaction are generated and placed into the queue 130. As a result, when the workflows 102 shift from being read-heavy to write-heavy, or vice versa, the cache controller 309 is able to predictively adapt the cache manager 120 to more efficiently respond to the future workload than conventionally possible. This results in the overall execution time for read/write transactions being reduced when compared to conventional cache management techniques.

In one example, the cache controller 309 may implement model predictive control (MPC) techniques to predict a future state of the cache 140 based the predicted future time horizon indicated by the expected IOPS pattern. In this example, the MPC controller may be trained to determine the impact on the cache 140 caused by modifying the functions 122-126 and to avoid suboptimal cache conditions. For example, the MPC controller may be trained to avoid needing to spin up additional storage for the cache 140, to avoid read and/or write times exceeding threshold durations, and/or other conditions. As a result, the MPC controller is able to model the impact of the expected IOPS pattern over time and the ability to modify the functions 122-126 to generate configuration outputs that avoid the conditions the MPC is specifically configured to avoid.

In other examples, different models may be implemented by the cache controller 309. For example, the cache controller 309 may include a neural network adapted to classify the expected IOPS pattern as belonging to one of plurality of different states. Each of these state may correspond to different set of parameters to apply when configuring the cache manager 120. In this example, a change in the expected IOPS pattern may viewed as a new stimulus to be evaluated by the neural network of the cache controller 309.

It should be appreciated that the workflow profiler 107 may also include components that identify other conditions that impact the state of the cache 140. For example, the workflow profiler 307 may include a component that detects a read-heavy workflow that has read-and-keep operations. These types of operations may occur when a read operation fetches a zip file from the cloud storage system 150 and the component files are extracted into the cache 140. Accordingly, the cache manager 120 may synchronize the read locks on the zip file and the extracted files.

As another example, the workflow profiler may include a component that detects a write-heavy workflow that also writes temporary files to the cache 140. Because the instant techniques may increase the number of write-back workers in response to a predicted write-heavy IOPS pattern, the write-back function 124 is more likely to detect that these temporary files have not been written to the cloud storage 150 and generate a corresponding write operation. To avoid accidentally writing temporary data to the cloud storage 150 (and incurring the corresponding costs associated with the write operations), the workflow profiler 107 may be configured to detect workflows 102 that generate temporary files such that the cache manager 120 can associate the temporary files with a flag or other indicator that prevents the write-back function 124 from writing the temporary data to the cloud storage 150.

### III. Example Methods

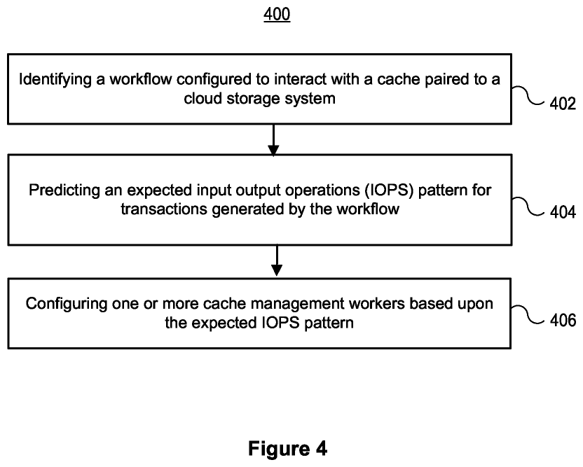

FIG. 4 is an example flow diagram of an example method 400 for predictive cache management, which can be implemented in the environment 100 of FIG. 1. More particularly, the method 400 may be executed, in part, by one or more processors on which the workspace 110 is instantiated.

The method 400 begins at block 402 when the one or more processors identify a workflow (such as the workflows 102) configured to interact with a cache (such as the cache 140) paired to a cloud storage system (such as the cloud storage system 150). For example, the workflow may be manually created via a workflow editor or automatically generated by one or more applications (such as the applications 112) of the workspace.

At block 404, the one or more processors predict an expected input output operations (IOPS) pattern for transactions generated by the workflow. For example, the IOPS pattern may be indicative of a proportion of read operations to write operations. In some embodiments, the one or processors are configured to analyze, via a workflow profiler, the workflow to predict whether the expected IOPS pattern is one of a read-heavy IOPS pattern or a write-heavy IOPS pattern. More particularly, the workflow profiler may identify component actions of the workflow to predict the IOPS pattern for the component actions. In these embodiments, the one or more processors may be configured to train, a model corresponding to a component action of the workflow (e.g., by using the action models 306) based upon a detected IOPS pattern when executing the component action. Additionally, in some embodiments, the one or more processors are configured to predict when the expected IOPS pattern for the component actions of the workflow are to commence (e.g., by using the timing predictor 308). In embodiments where the workflow includes two or more function blocks, the one or more processors are configured to predict the expected IOPS pattern for each function block of the workflow.

At block 406, the one or more processors configure one or more cache management workers (such as workers configured to perform the functions 122-126) based upon the expected IOPS pattern. For example, if the one or more processors determine that the expected IOPS pattern is a read-heavy IOPS pattern, the one or more processors may perform at least one of increasing an initial amount of document associated read into the cache by a pager worker in response to a read operation, increasing a number of pager workers, and increasing a number of related documents predictively loaded into the cache. On the other hand, if the one or more processors determine that the expected IOPS pattern is a write-heavy IOPS pattern, the one or more processors may perform at least one of increasing a number of data write-back workers, increasing a number of data reaper workers, and decreasing a number of pager workers. Additionally, in some embodiments associated with write-heavy IOPS patterns, the one or more processors determine that a component workflow action wrote one or more temporary files to the cache and flag the one or more temporary files such that the write-back workers do not write the temporary files to the cloud storage system.

In some further embodiments, the workflow is a first workflow and the one or more processors identify a second workflow configured to interact with the cache. Accordingly, one the embodiments, the one or more processors predict an expected IOPS pattern for transactions generated by the second workflow to predict an expected aggregate IOPS pattern for the transaction generated by the first and second workflows. In response, the one or more processors configure the one or more cache management workers based upon the expected aggregate IOPS pattern.

### IV. Additional Considerations

The following additional considerations apply to the foregoing discussion. Throughout this specification, plural instances may implement operations or structures described as a single instance. Although individual operations of one or more methods are illustrated and described as separate operations, one or more of the individual operations may be performed concurrently, and nothing requires that the operations be performed in the order illustrated. These and other variations, modifications, additions, and improvements fall within the scope of the subject matter herein.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of “a” or “an” is employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for identifying and grouping likely textual near-duplicates through the principles disclosed herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed:

1. A computer-implemented method for predictive cache management comprising:
identifying, via one or more processors, a workflow configured to interact with a cache paired to a cloud storage system;
predicting, via the one or more processors, an expected input output operations (IOPS) pattern for transactions generated by the workflow, wherein the IOPS pattern is indicative of a proportion of read operations to write operations; and
configuring, via the one or more processors, one or more cache management workers based upon the expected IOPS pattern.

2. The computer-implemented method of claim 1, wherein predicting the expected IOPS pattern comprises:
analyzing, via a workflow profiler, the workflow to predict whether the expected IOPS pattern is one of a read-heavy IOPS pattern or a write-heavy IOPS pattern.

3. The computer-implemented method of claim 2, wherein the workflow profiler identifies component actions of the workflow to predict the IOPS pattern for the component actions.

4. The computer-implemented method of claim 3, further comprising:
training, via the one or more processors, a model corresponding to a component action of the workflow based upon a detected IOPS pattern when executing the component action.

5. The computer-implemented method of claim 3, wherein predicting the expected IOPS pattern comprises:
predicting, via the one or more processors, when the expected IOPS pattern for the component actions of the workflow are to commence.

6. The computer-implemented method of claim 2, wherein configuring the one or more cache management workers comprises:
determining, via the one or more processors, that the expected IOPS pattern is a read-heavy IOPS pattern; and
performing, via the one or more processors, at least one of increasing an initial amount of document associated read into the cache by a pager worker in response to a read operation, increasing a number of pager workers, and increasing a number of related documents predictively loaded into the cache.

7. The computer-implemented method of claim 2, wherein configuring the one or more cache management workers comprises:
determining, via the one or more processors, that the expected IOPS pattern is a write-heavy IOPS pattern; and
performing, via the one or more processors, at least one of increasing a number of data write-back workers, increasing a number of data reaper workers, and decreasing a number of pager workers.

8. The computer-implemented method of claim 7, further comprising:
detecting, via the one or more processors, that a component workflow action wrote one or more temporary files to the cache; and
flagging, via the one or more processors, the one or more temporary files such that the write-back workers do not write the temporary files to the cloud storage system.

9. The computer-implemented method of claim 1, wherein:
the workflow includes two or more function blocks; and
predicting the expected IOPS pattern comprises predicting, via the one or more processors, the expected IOPS pattern for each function block of the workflow.

10. The computer-implemented method of claim 1, wherein:
the workflow is a first workflow; and
the method further comprises:
identifying, via one or more processors, a second workflow configured to interact with the cache; and
predicting, via the one or more processors, an expected IOPS pattern for transactions generated by the second workflow;
predicting, via the one or more processors, an expected aggregate IOPS pattern for the transaction generated by the first and second workflows; and
configuring, via the one or more processors, the one or more cache management workers based upon the expected aggregate IOPS pattern.

11. A system for predictive cache management comprising:
a cache;
one or more processors; and
one or more non-transitory memories coupled to the one or more processors and storing instructions that when executed by the one or more processors, cause the one or more processors to:
identify a workflow configured to interact with the cache paired to a cloud storage system;
predict an expected input output operations (IOPS) pattern for transactions generated by the workflow, wherein the IOPS pattern is indicative of a proportion of read operations to write operations; and
configure one or more cache management workers based upon the expected IOPS pattern.

12. The system of claim 11, wherein to predict the expected IOPS pattern, the instructions, when executed, cause the one or more processors to:
analyze, via a workflow profiler, the workflow to predict whether the expected IOPS pattern is one of a read-heavy IOPS pattern or a write-heavy IOPS pattern.

13. The system of claim 12, wherein the workflow profiler identifies component actions of the workflow to predict the IOPS pattern for the component actions.

14. The system of claim 13, wherein the instructions, when executed, cause the one or more processors to:
train a model corresponding to a component action of the workflow based upon a detected IOPS pattern when executing the component action.

15. The system of claim 13, wherein to predict the expected IOPS pattern, the instructions, when executed, cause the one or more processors to:
predict when the expected IOPS pattern for the component actions of the workflow are to commence.

16. The system of claim 12, wherein to configure the one or more cache management workers, the instructions, when executed, cause the one or more processors to:
determine that the expected IOPS pattern is a read-heavy IOPS pattern; and
perform at least one of increasing an initial amount of document associated read into the cache by a pager worker in response to a read operation, increasing a number of pager workers, and increasing a number of related documents predictively loaded into the cache.

17. The system of claim 12, wherein to configure the one or more cache management workers, the instructions, when executed, cause the one or more processors to:
determine that the expected IOPS pattern is a write-heavy IOPS pattern; and
perform at least one of increasing a number of data write-back workers, increasing a number of data reaper workers, and decreasing a number of pager workers.

18. The system of claim 17, wherein the instructions, when executed, cause the one or more processors to:
detect that a component workflow action wrote one or more temporary files to the cache; and
flag the one or more temporary files such that the write-back workers do not write the temporary files to the cloud storage system.

19. The system of claim 11, wherein:
the workflow is a first workflow; and
the instructions, when executed, cause the one or more processors to:
identify a second workflow configured to interact with the cache; and
predict an expected IOPS pattern for transactions generated by the second workflow;
predict an expected aggregate IOPS pattern for the transaction generated by the first and second workflows; and
configure the one or more cache management workers based upon the expected aggregate IOPS pattern.

20. A non-transitory computer-readable medium storing instructions for predictive cache management that, when executed via one or more processors of a computer system, cause the computer system to:
identify a workflow configured to interact with a cache paired to a cloud storage system;
predict an expected input output operations (IOPS) pattern for transactions generated by the workflow, wherein the IOPS pattern is indicative of a proportion of read operations to write operations; and
configure one or more cache management workers based upon the expected IOPS pattern.
